(19) United States
(12) Patent Application Publication
(10) Pub. No.: US 2014/0021174 A1
(43) Pub. Date: Jan. 23, 2014

(54) METHOD FOR REINFORCING WELDING TIP AND WELDING TIP

(71) Applicant: FUJI KIHAN CO., LTD., Aichi (JP)

(72) Inventor: Yoshio MIYASAKA, Aichi (JP)

(73) Assignee: FUJI KIHAN CO., LTD., Aichi (JP)

(21) Appl. No.: 13/867,202

(22) Filed: Apr. 22, 2013

(30) Foreign Application Priority Data
Jul. 23, 2012 (JP) 2012-162733

(51) Int. Cl. B23K 35/02; B23K 35/40; B23K 10/02

(52) U.S. Cl. CPC B23K 35/0261; B23K 10/02; B23K 35/404
USPC 219/121.45; 219/146.22; 427/61

(57) ABSTRACT

In order to extend a lifetime of a welding tip in a simple way, a surface reinforcing layer 2 is formed by ejecting a metal powder shot onto at least an inner peripheral surface of a welding tip 1 (1, 12) formed of any material of copper, a copper alloy or ceramic-dispersed copper at an ejection velocity of 100 m/sec or higher. The metal powder shot has an average particle diameter of 40 to 150 μm and hardness equal to or higher than the material of the welding tip 1 (11, 12). Then, a semiconductor film 3 is formed on the surface reinforcing layer 2 by further ejecting a tin powder with an average particle diameter of 10 μm to 100 μm having a tin oxide film formed thereon onto the surface reinforcing layer 2 at an ejection velocity of 200 m/sec or higher.

### BACKGROUND OF THE INVENTION

1. Field of the Invention

The present invention relates to a method for reinforcing a welding tip, and a welding tip reinforced by the method. More specifically, the present invention relates to a method for reinforcing a contact tip for forming a power distribution point with an electrode wire in arc welding and a nozzle tip for ejecting plasma while surrounding the outer periphery of an electrode rod in plasma welding (both tips are collectively referred to as a “welding tip” in this specification), and a welding tip reinforced by the method.

2. Description of the Related Art

As a welding method employed in a welding line in automobile manufacturing, etc., resistance welding such as spot welding and seam welding has been conventionally mainstream due to a demand for higher production speed.

However, from a demand for reduced fuel consumption in recent years, improvement in the strength of a welded part has been requested to reduce the weight of automobiles, etc. Accordingly, arc welding and plasma welding superior to resistance welding in this regard have been employed.

In addition, the situation of recent power supply shortage and the like has also been one of the reasons to consider shift to arc welding and plasma welding with lower power consumption than resistance welding.

However, arc welding and plasma welding cause lower productivity since longer working hours are required than resistance welding. Accordingly, in order to employ these welding methods instead of resistance welding, improvement in welding speed has been requested.

MIG welding, which is a consumed-type welding method using an electrode rod as a filler metal, is now described as an example of arc welding. As shown in FIG. 2, a front end portion of a torch used for this MIG welding is provided with a gas nozzle 4 through which an inert gas is introduced. Further, a contact tip 1 (11) which is a welding tip is concentrically disposed in the gas nozzle 4, and an electrode rod 5 which is a filler metal is inserted into the contact tip 11 in a contact state, thereby allowing electric current to flow to the electrode rod 5. Moreover, the passage of an inert gas is formed between the outer periphery of the contact tip 11 and the inner periphery of the gas nozzle 4. Therefore, continuous welding can be carried out by melting and feeding the electrode rod 5 by the heat of an arc generated between a workpiece W and the electrode rod 5 inserted into the contact tip 11.

A front end portion of a torch used for plasma welding is provided with an electrode rod 6 such as a tungsten rod, a nozzle tip 12 disposed at the outer periphery of this electrode rod 6, and a shield ring 7 covering the outer periphery of the nozzle tip 12 as shown in FIG. 3. An arc (non-transferred arc) generated between the electrode rod 6 and the nozzle tip 12, or an arc (transferred arc) generated between the electrode rod 6 and a workpiece W causes expansion of plasma gas introduced between the outer periphery of the electrode rod 6 and the inner periphery of the nozzle tip 12 with the heat of the arc, and the plasma gas is thus ejected at high velocity through a nozzle hole 121 provided at the front end of the nozzle tip 12. A shielding gas is caused to flow between the outer periphery of the nozzle tip 12 and the inner periphery of the shield ring 7 to control spread of a plasma jet.

The welding tip 1 (11, 12) configured as described above undergoes wear and tear by sliding contact with the electrode rod 5 or contact with plasma under a high temperature due to its structure. In addition, replacement of the welding tip is required since adhesion of adhering substances by sputtering and the like lead to a relatively short lifetime.

Particularly, when a production speed is increased in employing these welding methods instead of resistance welding as described above, replacement of the welding tip 1 (11, 12) is required for a shorter time.

Accordingly, general practice is to introduce expensive robots in a welding line to improve productivity with full automation in automobile production, etc. However, replacement of the welding tip 1 (11, 12) requires shutdown of the welding line routinely and frequently, such as every hour, for example, and a manual replacing work. Such requirements for replacement work are causes of significant reduction in productivity.

In addition, since the welding tip 1 (11, 12) to be replaced is required to have high electrical conductivity, copper, a copper alloy such as chromium copper, ceramic-dispersed copper and the like are used as a material of the welding tip 1 (11, 12). Such welding tips are expensive. If replacement frequency can be reduced, the manufacturing cost can be decreased.

Since ceramic-dispersed copper has excellent wear resistance and the like as compared with chromium copper, use of the ceramic-dispersed copper can reduce replacement frequency. However, ceramic-dispersed copper is 1.2 to 2 times as expensive as chromium copper and the effect corresponding to a difference of the price cannot be obtained.

Accordingly, it is desired to be relatively simple and low cost, and to improve the lifetime of the welding tip significantly.

For the purpose of improving wear resistance and the like of such a welding tip, the present inventor already has proposed that a hard shot having a particle diameter of 40 μm to 300 μm and hardness equal to or higher than that of a nozzle tip was ejected onto the surface of the nozzle tip made of nonferrous metal at an ejection velocity of 100 m/sec or higher to increase the temperature in the vicinity of the surface of the nozzle tip to the recrystallization temperature or higher to miniaturize a metal structure of the surface of the nozzle tip in process of recovery and recrystallization, thereby obtaining a nozzle tip with improved electrical conductivity and improved surface hardness (Japanese Patent KOKAI (LOPI) No. H8-150483 (JP8-150483A)).

Moreover, irrelevant to a processing technique associated with the welding tip, in order to reinforce the surface of a sliding part of a cutting tool, a metal molding die, a gear, a shaft and the like to achieve improved wear resistance and higher surface hardness, the present inventor also already has proposed that a tin powder with an average particle diameter of 10 μm to 100 μm having an oxide film formed on a surface thereof was ejected onto a product to be processed at an ejection pressure of 0.5 MPa or higher, or at an ejection velocity of 200 m/sec or higher, thereby forming a tin oxide film with a thickness of 1 μm or less on the surface of the product to be processed (Japanese Patent KOKAI (LOPI) No. 2009-270176 (JP2009-270176A)).

As described above, JP8-150483A has disclosed that a shot having a certain particle diameter and hardness equal to or higher than that of the nozzle tip was ejected onto the surface of the nozzle tip at a certain ejection velocity to increase the surface hardness, thereby improving wear resistance of the nozzle tip.

However, the welding tip obtained by the processing described in JP8-150483A stated above has had a certain plateau in hardness increase, and there has been a limitation of improved lifetime of the welding tip only with the processing described in JP8-150483A.

Accordingly, it is desired that replacement frequency of the welding tip be reduced by further increasing the lifetime of the welding tip, thereby reducing the frequency of shutdown of the welding line to further improve productivity.

The present invention is on the continuation of the invention according to JP8-150483A mentioned above, and aims at providing a long lasting welding tip by a relatively simple method at a low cost to meet the request of extension of the lifetime in the above market, the welding tip having further improved wear resistance and abrasion resistance in comparison with the welding tip processed by the method according to JP8-150483A stated above to meet the request of extension of the lifetime in the above market.

As introduced as JP2009-270176A mentioned above, the present inventor also already has proposed a method for improving wear resistance, in which a tin powder with a certain average particle diameter having a tin oxide film formed thereon was ejected onto the sliding part of a product to be processed under certain ejection conditions to form a tin oxide film which is a hard material on the surface of the sliding part.

Thus, when the tin oxide film is further formed by the method according to JP2009-270176A after surface reinforcement is carried out by the method according to JP8-150483A, further improved surface hardness may be obtained by the synergistic effect of both inventions.

However, a material of the film formed on the surface of the sliding part by the method according to JP2009-270176A mentioned above is tin oxide, that is, a “semiconductor”, which is a substance with extremely high electrical resistance to a conductive material such as copper which is a base material of the welding tip, at a temperature of about room temperature (25° C.).

Accordingly, when such a tin oxide film is formed on the part required to have high electrical conductivity like the inner peripheral surface of the welding tip, required characteristics may be lost. Therefore, the invention according to JP2009-270176A mentioned above has a reason (obstructive factor) which obstructs application of the tin oxide film to the part required to have conductivity, such as the inner peripheral surface of the welding tip.

Antimony-doped tin oxide (ATO) which is a tin oxide with a dopant such as antimony added therein, is a substance exhibiting good conductivity, for example, used as a transparent electrode of a display panel. Therefore, when the inner peripheral surface of the welding tip is intended to be coated by the tin oxide film without impairing conductivity, a film can be also formed by antimony-doped tin oxide.

However, if a film is formed using expensive antimony-doped tin oxide, the obtained welding tip is also expensive so that the price competitiveness may be lost in the market. Further, since antimony is a substance with a large burden to the environment, use of antimony is preferably restricted if possible.

In light of the above points, the present inventor has attempted to form a tin oxide film without adding impurities after ejection of a hard shot onto the inner peripheral surface of the welding tip in spite of and on the contrary to the above-mentioned reason (obstructive factor).

As a result, even though the surface hardness was once increased by ejection of the hard shot and thereafter the tin oxide film was formed, the surface hardness was not increased any more. Therefore, improved mechanical characteristics such as further increased surface hardness which is expected as a synergistic effect of combination of the above two inventions was unable to be obtained.

On the other hand, the inner peripheral surface of the welding tip thus processed has required conductivity also by formation of the semiconductor film without doping (addition of impurities) although the reason is unknown, and it is sufficient to withstand the use as a welding tip. Furthermore, the welding tip thus processed causes less wear and tear although improved mechanical characteristics such as increased hardness are not obtained. In addition, generation of welding defect was drastically decreased, providing increased characteristics which cannot be expected from combination of conventional arts mentioned above.

### SUMMARY OF THE INVENTION

Means to solve the above problems will now be described below with reference numerals used in the detailed description of the preferred embodiments. The reference numerals are intended to clarify correspondence between description of the claims and description of the preferred embodiments for carrying out the invention, and needless to say, are not restrictively used for understanding the technical scope of the present invention.

As described above, the present invention has been made in light of unexpected effects such that combination of two kinds of processings mentioned above allows formation of a semiconductor film without losing conductivity, and improves wear resistance and the like even though increased hardness is not observed.

A method for reinforcing a welding tip 1 (11, 12) of the present invention comprises:

a step of forming a surface reinforcing layer 2 by ejecting a metal powder shot onto at least an inner peripheral surface of a welding tip 1 (11, 12) formed of any material of copper, a copper alloy or ceramic-dispersed copper at an ejection velocity of 100 m/sec or higher, the metal powder shot having an average particle diameter of 40 μm to 150 μm and hardness equal to or higher than the material of the welding tip 1 (11, 12); and

a step of forming a semiconductor film 3 of tin oxide on the surface reinforcing layer 2 by further ejecting a tin powder with an average particle diameter of 10 μm to 100 μm having a tin oxide film formed thereon onto the surface reinforcing layer 2 formed in said step of forming the surface reinforcing layer at an ejection velocity of 200 m/sec or higher.

In the method for reinforcing a welding tip, the welding tip 1 to be processed may be a contact tip 11 provided at a front end of a torch for inert gas arc welding or CO₂ gas arc welding.

Moreover, in the method for reinforcing the welding tip, the welding tip 1 to be processed may be a nozzle tip 12 provided at a front end of a torch for plasma welding.

In the step of forming the surface reinforcing layer described above, the surface reinforcing layer 2 to which component reinforcement, high hardness, and compressive stress are imparted may be formed, and the component reinforcement is attributed to diffusion and penetration of a component of the metal powder shot into the inner peripheral surface, the high hardness is attributed to miniaturization of a metal structure in the vicinity of the surface of the inner peripheral surface, and the compressive stress is accompanied by plastic deformation attributed to collision of the metal powder shot.

A welding tip 1 (11, 12) of the present invention comprises:

a surface reinforcing layer 2 formed by ejecting a metal powder shot at least onto an inner peripheral surface of the welding tip 1 (11, 12) formed of any material of copper, a copper alloy or ceramic-dispersed copper at an ejection velocity of 100 m/sec or higher, the metal powder shot having an average particle diameter of 40 μm to 150 μm and hardness equal to or higher than the material of the welding tip 1 (11, 12); and

a semiconductor film 3 of tin oxide formed on the surface reinforcing layer 2 by ejecting a tin powder with an average particle diameter of 10 μm to 100 μm having a tin oxide film formed thereon onto the surface reinforcing layer 2 at an ejection velocity of 200 m/sec or higher.

The welding tip 1 may be a contact tip 11 which has the inner peripheral surface in sliding contact with an outer peripheral surface of an electrode and is provided at a front end of a torch for arc welding. Moreover, the welding tip 1 may be a nozzle tip 12 which has the inner peripheral surface defining a space for introduction of plasma gas and is provided at a front end of a torch for plasma welding.

A component of the metal powder shot is diffused and penetrated into the surface reinforcing layer 2 and the surface reinforcing layer 2 has a miniaturized metal structure and compressive stress.

The configuration of the present invention described above allows the welding tip with the surface reinforced by the method of the present invention to have the following prominent effects.

Formation of both the surface reinforcing layer 2 and the semiconductor film 3 made of tin oxide on the inner peripheral surface by the aforementioned method provides a lifetime which is 7 to 8 times longer than that of an unprocessed welding tip, and 2 to 3.5 times longer than that of a conventional welding tip having only a surface reinforcing layer formed thereto.

Since tin oxide forming a film on the inner peripheral surface of the welding tip is a semiconductor as described above, it is anticipated that with respect to the welding tip 1 having the semiconductor film 3 made of tin oxide formed on the inner peripheral surface by the method of the invention, decreased conductive performance of the inner peripheral surface would cause a problem of power distribution with the electrode rod in the contact tip for arc welding, and a problem of plasma generation and the like in the nozzle tip for plasma welding, thereby leading to welding defect or making welding itself impossible in some cases. However, when the semiconductor film 3 of tin oxide was formed on the surface reinforcing layer 2 by the method of the present invention, it was observed that the welding tip 1 exhibited an unexpected function such as good conductivity even without any doping although the principle is unknown.

Further, in a general copper welding tip, as the temperature is increased by heating during welding, the electrical resistance is increased in proportion to increase of the temperature. This has accelerated wear of the welding tip and resulted in frequent generation of welding defect. In the welding tip with the surface reinforced by the method of the present invention, however, increased temperature of the welding tip rather caused lower electrical resistance of the inner peripheral surface, which gave such effects that generation of welding defect was drastically decreased without acceleration of wear and tear speed.

In brief, since larger charge carrier density in a conduction band results in smaller electrical resistance in a semiconductor such as tin oxide, the charge carrier density is generally increased by increasing the atoms of a dopant to supply free electrons to a conduction band or to generate holes in a valence band, whereby the electrical resistance is decreased (conductivity is improved). In such a semiconductor, it is considered that charge carriers excited by heat would be dominant at high temperature and the electrical resistance was exponentially decreased with increase of the temperature regardless of the amount of the dopant.

Furthermore, tin oxide has high hardness of HV 1650 kg/mm² and a high melting point of 1630° C., providing thermal resistance. As a result, peeling and the like of the semiconductor film 3 is hardly caused even when the semiconductor film 3 is in sliding contact with the electrode rod and the like at high temperature.

As shown in FIG. 4, when the temperature of tin oxide which is a semiconductor is increased in the air, the amount of oxygen negatively charged and adsorbed to the surface of tin oxide is increased. Further, the adsorbed oxygen captures electrons required for electrical conduction of tin oxide to increase a potential depletion layer formed on the tin oxide surface, thereby making a potential barrier higher to increase the electrical resistance.

However, when the welding tip of the present invention is used under a non-oxidative atmosphere, such as when used under introduction of inert gas such as Ar like the contact tip for inert gas arc welding, when used under introduction of carbon dioxide like the contact tip for CO₂ gas arc welding, as well as when used under introduction of plasma gas such as argon, hydrogen, and nitrogen like the nozzle tip for plasma welding, increase of the resistance with negative charge adsorption of new oxygen can be prevented, and it is supposed that decrease of the electrical conductivity with increase of the temperature can also be suppressed in this regard.

### BRIEF DESCRIPTION OF THE DRAWINGS

The objects and advantages of the invention will become apparent from the following detailed description of preferred embodiments thereof provided in connection with the accompanying drawings in which:

FIG. 1 is a schematic cross-sectional view illustrating the welding tip of the present invention;

FIG. 2 is an explanatory view illustrating a front end portion of a torch for gas shielded arc welding (MIG welding);

FIG. 3 is an explanatory view illustrating a front end portion of a torch for plasma welding; and

FIG. 4 is an explanatory view illustrating the mechanism of increasing the electric resistance with oxygen adsorption to a tin oxide film.

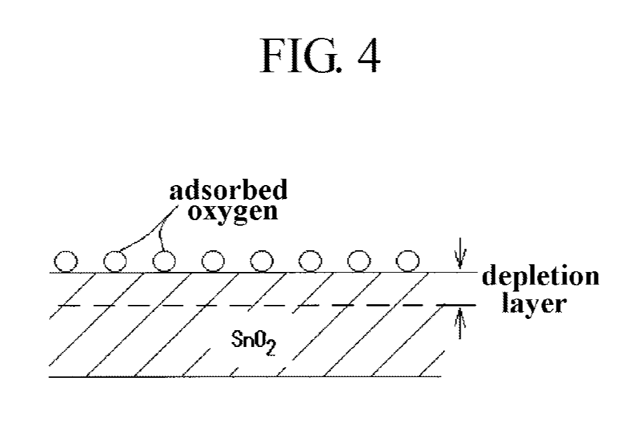

### DETAILED DESCRIPTION OF PREFERRED EMBODIMENTS

Next, the embodiments of the present invention will be described below with reference to the accompanying drawings.

### Outline of Manufacturing Method

A method for reinforcing the welding tip of the present invention includes: a step of forming a surface reinforcing layer 2 in the vicinity of an inner peripheral surface of a welding tip by ejecting a metal powder shot having hardness higher than that of a base material of the welding tip onto at least the inner peripheral surface of the welding tip; and a step of forming a semiconductor film 3 of tin oxide by further ejecting a tin powder shot having a tin oxide film formed thereon onto the surface reinforcing layer 2.

### Subject to be Processed

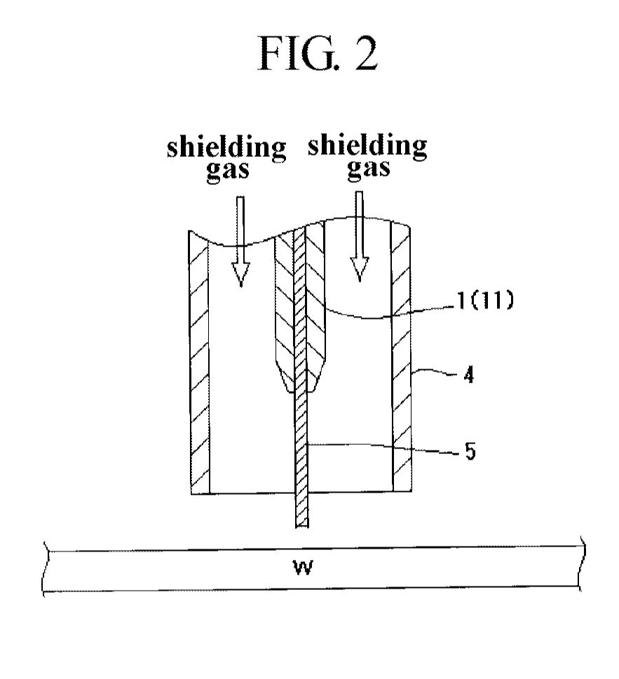

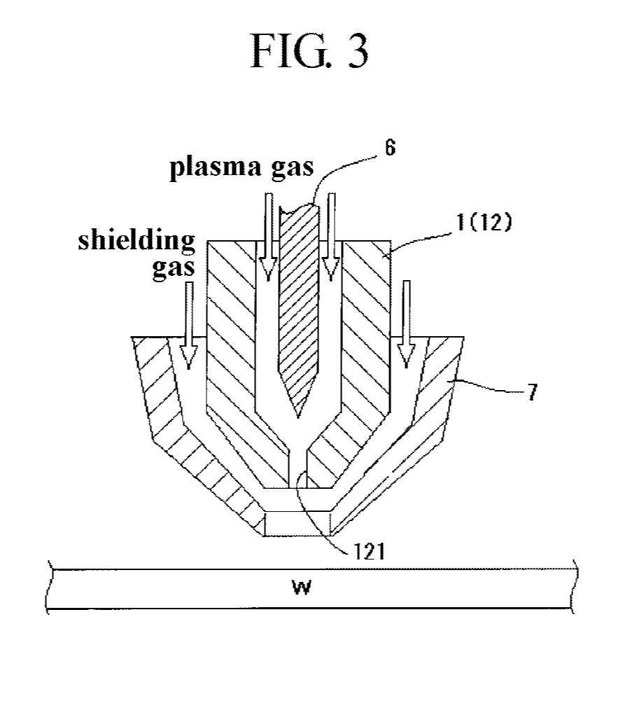

The welding tip to be processed in the present invention includes both of a contact tip 11 which is provided in a torch for arc welding described with reference to FIG. 2 and forms a power distribution point with an electrode rod 5, and a nozzle tip 12 which is provided in a torch for plasma welding as described with reference to FIG. 3 and covers an outer periphery of an electrode rod 6.

The contact tips for arc welding include various kinds of contact tips according to the difference of welding types, such as a contact tip for submerged arc welding, a contact tip for inert gas arc welding, and a nozzle tip for CO₂ gas arc welding, but the method of the present invention is applicable to any of these. Also, in the method of the present invention, both of a contact tip used for consumable welding with an electrode rod itself as a filler metal like MIG welding and a contact tip used for non-consumable welding with hardly consuming an electrode rod itself like TIG welding can be used as a subject to be processed.

Since the welding tip 1 (11, 12) for both are welding and plasma welding is required to have high conductivity, copper, a copper alloy, and ceramic-dispersed copper are used as a material, and any of these can be processed in the present invention.

In addition, chromium copper, zirconium copper and the like are copper alloys generally used for the welding tip, and the present invention is applicable to any of these. Further, not limited to these, the present invention is also applicable to welding tips made of other copper alloys.

### Processing Device

In both the step of forming the surface reinforcing layer and the step of forming the semiconductor film according to the present invention, a commercially available air type blasting device which is applied for known sandblasting and shot peening and the like can be used.

As an air type blasting device, various types of blasting devices have been provided, such as a gravity type (suction type) and a direct pressure type. In the processing method of the present invention, any blasting device may be used as long as an ejection powder can be ejected with a compressed gas at a certain ejection velocity, and the type of ejection is not particularly limited as long as an air type blasting device is used.

### Step of Forming Surface Reinforcing Layer

The step of forming a surface reinforcing layer is carried out by first ejecting a metal powder shot having hardness equal to or higher than that of the base material of the welding tip onto at least the inner peripheral surface, preferably the inner peripheral surface and the outer peripheral surface of the above-mentioned welding tip, to form the surface reinforcing layer 2 in the vicinity of the surface of the welding tip at the ejection position.

Examples of the metal powder shot used for ejection may include high-speed steel and tungsten. Other than these, various kinds of metal powder shot can be used as long as the metal powder shot is formed of a metal material having hardness equal to or higher than that of the base material of the welding tip.

In addition, by ejecting the metal powder shot at high velocity to cause collision with the surface of the welding tip, part of a component of the metal powder shot can be diffused and penetrated in the vicinity of the surface of the welding tip. Therefore, for example, for the purpose of reinforcing and modifying copper or a copper alloy which is a base material of the welding tip, when other elements are diffused and penetrated thereto, components to be diffused and penetrated are included in the metal powder shot.

The metal powder shot used for ejection has an average particle diameter of 40 μm to 150 μm, and it is ejected at an ejection velocity of 100 m/sec or higher.

The reason for the shot diameter of 40 μm to 150 μm is that the shot diameter is required to be smaller in order to obtain a high ejection velocity, the surface roughness of the processed surface is made uniform and adjusted to give a contact surface which does not increase the electrical resistance. Further, the reason for the ejection velocity of 100 m/sec or higher is that it is a required condition in the above shot diameter to increase the temperature in the vicinity of the surface of the welding tip which is copper or a copper alloy with high heat dissipation to a required temperature, for example, the recrystallization temperature or higher.

In this way, when the metal powder shot is ejected at least onto the inner peripheral surface of the welding tip under the aforementioned conditions, heating and cooling are repeated by collision of the shot on the surface of the welding tip in collision with the shot, thereby miniaturize a structure in the vicinity of the surface of a collision part. At the same time, compressive stress is imparted to the collision part, which is then reinforced.

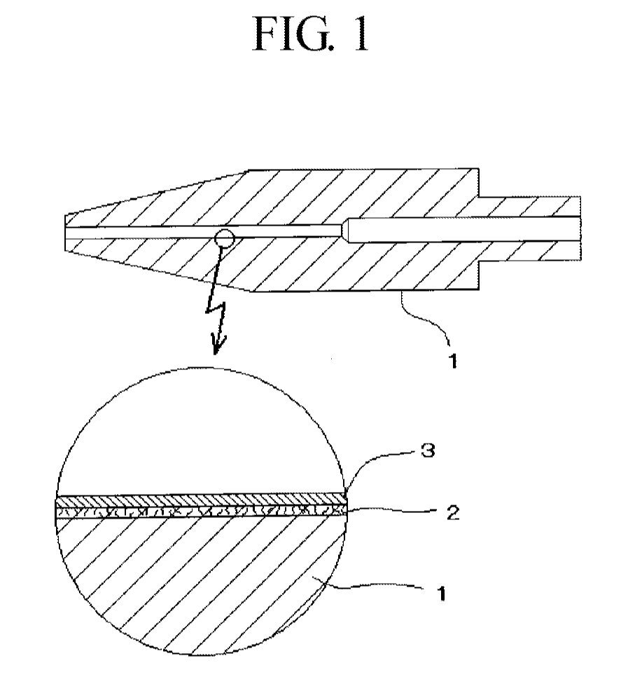

Part of the component in the metal powder shot is diffused and penetrated in the vicinity of the surface of the collision part to form the surface reinforcing layer 2 in the vicinity of the surface of the welding tip as shown in the enlarged drawing in FIG. 1.

The surface reinforcing layer 2 formed in this way obtains increased electrical conductivity attributed to a miniaturized structure as compared with the surface of an unprocessed inner peripheral surface of the welding tip.

### Step of Forming Semiconductor Film

The step of forming a semiconductor film is performed by further ejecting a tin powder onto the surface reinforcing layer 2 formed by the above step to form the semiconductor film 3 of tin oxide.

As a tin powder to be ejected, one having a tin oxide film formed on the surface is used, and adhesion, diffusion, and penetration of this tin oxide to the inner peripheral surface of the welding tip causes formation of the semiconductor film 3 mentioned above.

The tin powder covered with such an oxide film can be obtained by manufacturing the tin powder with a water atomization method as an example. In this water atomization method, collision of molten tin with high-pressure water causes powderization and rapid solidification of molten tin in an instant, thereby obtaining a powder. In the tin powder obtained in this way, the surface thereof is oxidized by quenching in collision with water, providing the tin powder having the surface covered with an oxide film.

The tin powder to be used has an average particle diameter of 10 μm to 100 μm, preferably 20 μm to 50 μm. In order to form a film on the surface of a product to be processed by collision with the tin powder, it is necessary to increase the temperature of the tin powder by heating at collision, and this temperature increases in proportion to the collision velocity of the tin powder.

The tin powder having a particle diameter in the above range is easily carried by an air flow generated by a compressed gas used at ejection, and the ejection powder can be brought into collision with the surface of the product to be processed at a high velocity, thereby allowing suitable formation of the tin oxide film.

Each particle shape of the ejection powder to be used may be spherical, polygonal, or further a mixture of these and the shape thereof is not particularly limited.

The tin powder is ejected at an ejection velocity of 200 m/sec or higher. Increased temperature which is caused at a time of collision of the tin powder with the surface of the product to be processed is proportional to the velocity, and the tin powder is required to be ejected at a high velocity in order to suitably melt and adhere the tin powder to the surface of the product to be processed.

Particularly, the tin powder used in the method of the present invention has the oxide film formed on the surface thereof. Further, this oxide film (tin oxide) has a higher melting point than tin (unoxidized), and therefore the tin powder is required to be ejected at high ejection pressure and high ejection velocity as mentioned above.

As described above, the tin powder which has the oxide film formed on the surface and has an average particle diameter of 10 μm to 100 μm, preferably 20 μm to 50 μm is ejected at a relatively high velocity of 200 m/sec or higher and brought into collision with the inner peripheral surface of the welding tip. Then, the ejected tin powder comes into collision with the inner peripheral surface of the welding tip, and when the ejected tin powder is rebounded, part of the ejected tin powder melts and adheres to, or diffuses/penetrates into, and coats the inner peripheral surface to form the tin oxide film.

When tin powder is ejected at high velocity onto the inner peripheral surface of the welding tip at the ejection pressure or the ejection velocity mentioned above, a thermal energy is generated in the tin powder by the velocity change before and after collision against the surface of the product to be processed. Since this thermal energy is generated only in the deformed part with which the tin powder comes into collision, the temperature increases in the tin powder and locally in the vicinity of the inner peripheral surface of the welding tip, with which this tin powder comes into collision.

Since the temperature increases in proportion to the velocity of the tin powder before collision, a higher ejection velocity of tin powder ejection increases the temperature of the tin powder and the inner peripheral surface of the welding tip to high temperature. At this time, the tin powder is heated at the inner peripheral surface of the welding tip and accordingly this increased temperature causes oxidation of the temperature-increasing part of the tin powder. At the same time, it is considered that part of ejection powder which includes the oxide film formed on the surface of the tin powder is melted and adhered to, diffused and penetrated into, or coated on the surface reinforcing layer formed on the inner peripheral surface of the welding tip by the increased temperature, thereby forming the semiconductor film 3.

Tin as a metal is a soft metal with Vickers hardness of about 5 kg/mm². Tin oxide which is oxide of tin, is a substance with high hardness such as Vickers hardness of about 1650 kg/mm² at the maximum. The hardness of the tin oxide film formed in this way is sufficient to form a film which is not easily worn out as compared with ceramics such as zirconia (about HV 1100 kg/mm²), alumina (about HV 1800 kg/mm²), silicon carbide (about HV 2200 kg/mm²), and aluminum nitride (about HV 1000 kg/mm²).

Further, the tin oxide film formed in this way does not easily cause peeling and the like by sliding of the electrode rod, etc.

Moreover, tin has a low melting point of 232° C. but tin oxide has a high melting point of 1630° C. Therefore, even in use for the welding tip, the welding tip has thermal characteristics sufficient to withstand to heating during welding.

Tin oxide without doping is a semiconductor having high electrical resistance, but the inner peripheral surface of the welding tip after the semiconductor film 3 of tin oxide is formed on the surface reinforcing layer 2 by the aforementioned method exhibited good conductivity although the principle and the like are unknown.

In addition, in the welding tip which is not processed according to the present invention, the electrical resistance increases as the temperature increases, and such increased electrical resistance causes shortage of power supply to the electrode rod or increased power consumption. At the same time, increased electrical resistance further causes generation of heat, and the sliding contact of the welding tip with the electrode rod in such a state results in higher abrasion speed and shorter lifetime. This also causes welding defect based on shortage of power supply or loose contact. In the inner peripheral surface of the welding tip, on which the semiconductor film is formed by surface reinforcement processing according to the method of the present invention, the electrical resistance of the semiconductor film 3 decreases as the temperature of the welding tip increases. Therefore, good electrical conductivity is maintained without shortage of power supply, increased power consumption, further increased temperature based on increased electrical resistance and the like even when the temperature of the welding tip is increased by heating during welding. As a result, the welding tip is also hardly worn out by contact with the electrode rod or plasma, and welding defect is hardly caused.

### Effects and the Like

As described above, in the welding tip reinforced by the method of the present invention, the surface reinforcing layer 2 with high hardness is formed by ejection of the shot having hardness equal to or higher than the base material of the tip, and the semiconductor film 3 having thermal resistance and high hardness is further formed on the surface reinforcing layer 2, whereby not only decreased conductivity anticipated by formation of the semiconductor film 3 is not observed, but also good conductivity is exhibited without increased electrical resistance even when the welding tip is heated to high temperature.

As a result, in the welding tip to which the surface reinforcement processing of the present invention is carried out, even combination of two kinds of processings mentioned above does not increase the surface hardness, but expression of electrical characteristics which could not be expected from two kinds of processings mentioned above increased the lifetime of the welding tip to 7 to 8 times longer than that of the unprocessed welding tip, and 2 to 3.5 times longer than that of the welding tip having only the surface reinforcing layer 2 formed thereon, and at the same time, drastically decreased generation of welding defect.

Examples of the reinforcement processing carried out to the welding tip are described below. The results for evaluating the characteristics of the welding tip to which each processing is performed are shown below.

### Example 1

The reinforcement method of the present invention was carried out to a contact tip for arc welding (made of chromium copper; φ1.2 mm) under the following conditions.

### (1) Surface Reinforcement Processing

A metal powder was ejected to the inner peripheral surface and the outer surface of the contact tip under the following conditions, respectively.

TABLE 1
CONDITIONS FOR FORMING SURFACE REINFORCING LAYER
ON CONTACT TIP FOR ARC WELDING

| | | Outer surface | Inner peripheral surface |
|---|---|---|---|
| Blasting device | | Gravity type | DP-1 (manufactured by Fuji Manufacturing Co., Ltd.) |
| | | | Direct pressure pencil type |
| Ejection powder | Material | High-speed steel | High-speed steel |
| | Particle diameter | #150 (average 85 μm) | #300 (average 55 μm) |
| | Shape | Spherical | Spherical |
| | Manufacturing method | Gas atomization method | Gas atomization method |
| Ejection conditions | Pressure | 0.6 MPa | 0.5 MPa |
| | Velocity | about 150 m/sec | about 230 m/sec |
| | Nozzle diameter | Φ 9 mm (long) | Φ 1 mm |
| | Ejection distance | 100 mm | 10 mm from tip opening |
| | Ejection time | about 10 seconds | about 15 seconds |

### (2) Step of Forming Semiconductor Film

A tin powder was ejected onto the inner peripheral surface and the outer surface of the contact tip under the following conditions, respectively, after the surface reinforcement processing was completed under the above conditions.

TABLE 2
CONDITIONS FOR FORMING SEMICONDUCTOR FILM
ON CONTACT TIP FOR ARC WELDING

| | | Outer surface | Inner peripheral surface |
|---|---|---|---|
| Blasting device | | Gravity type | DP-I(manufactured by Fuji Manufacturing Co., Ltd.) |
| | | | Direct pressure pencil type |
| Ejection powder | Material | Tin (with oxide film) | Tin (with oxide film) |
| | Particle diameter | 40 μm | 40 μm |
| | Shape | Substantially spherical | Substantially spherical |
| | Manufacturing method | Water atomization method | Water atomization method |
| Ejection conditions | Pressure | 0.7 MPa | 0.5 MPa |
| | Velocity | about 240 m/sec | about 250 m/sec |
| | Nozzle diameter | Φ 9 mm (long) | Φ 1 mm |
| | Ejection distance | 150 mm | 5 mm from tip opening |
| | Ejection time | about 10 seconds | about 10 seconds |

### (3) Performance Evaluation

The results of performance evaluation are shown below in Table 3 for the contact tip of the present invention (Example 1) on which the surface reinforcing layer and the semiconductor film were formed under the above conditions, an unprocessed contact tip (Comparative Example 1), and a contact tip (Comparative Example 2) to which only the surface reinforcement processing was performed.

TABLE 3
PERFORMANCE EVALUATION OF CONTACT
TIP FOR ARC WELDING

| | | Comparative Example 2 | |
|---|---|---|---|
| | Comparative | (only surface | |
| | Example 1 | reinforcement | |
| | (unprocessed) | processing) | Example 1 |
| Surface hardness | 139 | 181 | 182 |
| (MHV) | | | |
| Stress (MPa) | 70 | 210 | 210 |
| Durability (hour) | 1 | 4 | 8 |
| Wire sliding | Normal | Good | Excellent |
| condition | | | |

### (4) Experimental Results

From the above results, the surface hardness was HV 139 kg/mm² in Comparative Example 1 (unprocessed), while it was HV 181 kg/mm² in Comparative Example 2 through the surface reinforcement step, showing that the diffusion effect of a metal component significantly improved hardness and stress, and increased the lifetime (durability) by 4 times.

As compared with the contact tips to which the surface reinforcement processing were thus performed, in the contact tip of the present invention to which the step of forming the semiconductor film was further carried out, improvement of hardness and stress was not observed relative to the contact tip to which only the surface reinforcement processing was carried out (Comparative Example 2), but increased lifetime (durability) was obtained such as 8 times longer than the unprocessed contact tip (Comparative Example 1) and also 2 times longer than the contact tip to which only the surface reinforcement processing was performed (Comparative Example 2).

The reason that the lifetime (durability) of the contact tip of the present invention was increased even though increased surface hardness or stress was not obtained relative to the contact tip to which only the surface reinforcement processing was carried out in this way (Comparative Example 2) is supposed to be the effect of high conductivity under the high temperature of the semiconductor film.

In addition, since the electrical conductivity was high under high temperature in this way, power consumption was able to be reduced, which was economical, and generation of welding defect caused by poor power supply was able to be drastically decreased at the same time. Further, the nozzle tip having the semiconductor film formed thereon gives good sliding of a wire. At the same time, since the semiconductor film of tin oxide has a high melting point and high hardness, it is hardly peeled even if in sliding contact with the electrode under high temperature, and the excellent electrical characteristics mentioned above can be continuously obtained for a long time.

Particularly, in this Example, the surface reinforcing layer and the semiconductor film of tin oxide were also formed on the outer surface of the contact tip. Accordingly, spatter was hardly adhered to any position of the contact tip during welding, and when adhered, it was able to be easily removed, thereby preventing the lifetime from being decreased by spatter adhesion.

### Example 2

The surface reinforcement processing of the present invention was performed on a nozzle tip (made of chromium copper, forged product: φ2.5 mm) for plasma welding under the following conditions, and the characteristics of the nozzle tip after processed were evaluated.

### (1) Surface Reinforcement Processing

A metal powder was ejected onto the inner peripheral surface and the outer surface of the nozzle tip under the following conditions, respectively.

TABLE 4
CONDITIONS FOR FORMING SURFACE REINFORCING LAYER
ON NOZZLE TIP FOR PLASMA WELDING

| | | Outer surface and Inner |
|---|---|---|
| | | peripheral surface |
| Blasting device | | Gravity type |
| Ejection powder | Material | High-speed steel |
| | Particle diameter | #150 (average 85 m) |
| | Shape | Spherical |
| | Manufacturing method | Gas atomization method |
| Ejection | Pressure | 0.6 MPa |
| conditions | Velocity | about 150 m/sec |
| | Nozzle diameter | Φ 9 mm (long) |
| | Ejection distance | 100 mm |
| | Ejection time | about 10 seconds (5 seconds |
| | | each for outer surface and |
| | | inner peripheral surface) |

### (2) Step of Forming Semiconductor Film

A tin powder was ejected onto the inner peripheral surface and the outer surface of the nozzle tip under the following conditions, respectively, after the surface reinforcement processing was completed under the above conditions.

TABLE 5
CONDITIONS FOR FORMING SEMICONDUCTOR FILM
ON NOZZLE TIP FOR PLASMA WELDING

| | | Outer surface and Inner |
|---|---|---|
| | | peripheral surface |
| Blasting device | | DP-1 (manufactured by Fuji |
| | | Manufacturing Co., Ltd. |
| | | Direct pressure pencil type |
| Ejection powder | Material | Tin (with oxide film) |
| | Particle diameter | 40 μm (# 400) |
| | Shape | Substantially spherical |
| | Manufacturing method | Water atomization method |
| Ejection | Pressure | 0.5 MPa |
| conditions | Velocity | about 250 m/sec |
| | Nozzle diameter | Φ 1 mm |
| | Ejection distance | 10 mm |
| | Ejection time | about 20 seconds (10 seconds |
| | | each for outer surface and |
| | | inner peripheral surface) |

### (3) Performance Evaluation

The results of performance evaluation are shown below in Table 6 for the nozzle tip of the present invention on which the surface reinforcing layer and the semiconductor film were formed under the above conditions (Example 2), an unprocessed nozzle tip (Comparative Example 3), and a nozzle tip to which only the surface reinforcement processing was performed (Comparative Example 4).

TABLE 6
PERFORMANCE EVALUATION OF NOZZLE
TIP FOR PLASMA WELDING

| | | Comparative | |
|---|---|---|---|
| | Comparative | Example 4 | |
| | Example 3 | (only surface | |
| | (unprocessed: | reinforcement | |
| | forged product) | processing) | Example 2 |
| Surface hardness (MHV) | 174 | 196 | 196 |
| Stress (MPa) | 80 | 210 | 210 |
| Durability (hour) | 1 | 2 | 7 |

### (4) Experimental Results

Although the nozzle tip for plasma welding is not in direct contact with an electrode rod unlike the aforementioned contact tip for arc welding, it is to focus a plasma gas which is heated and expanded by arc heat between the outer periphery of the electrode rod and the inner periphery of the nozzle tip through a nozzle hole and eject it at high velocity. Therefore, the abrasion and the like of the nozzle tip for plasma welding directly influence the quality of welding.

The surface hardness was HV 174 kg/mm² in the nozzle tip (unprocessed product: Comparative Example 3) which was made of chromium copper and manufactured by forging, while the hardness was increased to HV 196 kg/mm² in the nozzle tip to which the surface reinforcement processing was carried out (Comparative Example 4). Increased stress was also observed at the same time, but the lifetime (durability) was increased only by 2 times.

On the other hand, in the nozzle tip of the present invention on which the semiconductor film was further formed after the surface reinforcement processing (Example 2), improvement of hardness and stress was not observed relative to the nozzle tip to which only the surface reinforcement processing was carried out (Comparative Example 4), but increased lifetime (durability) was observed such as 7 times longer than the unprocessed product (Comparative Example 3) and 3.5 times longer than the surface reinforced product.

Even when compared with the case of using either the unprocessed product (Comparative Example 3) or the surface reinforced product (Comparative Example 4), generation of welding defect was confirmed to be drastically decreased.

In this way, although neither hardness nor stress was changed before and after formation of the semiconductor film, increased lifetime and drastically decreased welding defect were caused in the nozzle tip. Therefore, it is supposed that both of these effects were obtained by the fact that formation of the semiconductor film of tin oxide prevented deterioration of electrical conductivity (rather improved electrical conductivity) even at high temperature.

Thus the broadest claims that follow are not directed to a machine that is configured in a specific way. Instead, said broadest claims are intended to protect the heart or essence of this breakthrough invention. This invention is clearly new and useful. Moreover, it was not obvious to those of ordinary skill in the art at the time it was made, in view of the prior art when considered as a whole.

Moreover, in view of the revolutionary nature of this invention, it is clearly a pioneering invention. As such, the claims that follow are entitled to very broad interpretation so as to protect the heart of this invention, as a matter of law.

It will thus be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described;

What is claimed is:

1. A method for reinforcing a welding tip, comprising:
a step of forming a surface reinforcing layer by ejecting a metal powder shot onto at least an inner peripheral surface of a welding tip formed of any material of copper, a copper alloy or ceramic-dispersed copper at an ejection velocity of 100 m/sec or higher, the metal powder shot having an average particle diameter of 40 μm to 150 μm and hardness equal to or higher than the material of the welding tip; and
a step of forming a semiconductor film of tin oxide on the surface reinforcing layer by further ejecting a tin powder with an average particle diameter of 10 μm to 100 μm having a tin oxide film formed thereon onto the surface reinforcing layer formed in said step of forming the surface reinforcing layer at an ejection velocity of 200 m/sec or higher.

2. The method for reinforcing a welding tip according to claim 1, wherein the welding tip is a contact tip provided at a front end of a torch for inert gas arc welding or CO₂ gas arc welding.

3. The method for reinforcing the welding tip according to claim 1, wherein the welding tip is a nozzle tip provided at a front end of a torch for plasma welding.

4. The method for reinforcing a welding tip according to claim 1, wherein, in the step of forming the surface reinforcing layer, the surface reinforcing layer to which component reinforcement, high hardness, and compressive stress are imparted is formed, the component reinforcement being attributed to diffusion and penetration of a component of the metal powder shot into the inner peripheral surface, the high hardness being attributed to miniaturization of a metal structure in the vicinity of the surface of the inner peripheral surface, and the compressive stress being accompanied by plastic deformation attributed to collision of the metal powder shot.

5. The method for reinforcing a welding tip according to claim 2, wherein, in the step of forming the surface reinforcing layer, the surface reinforcing layer to which component reinforcement, high hardness, and compressive stress are imparted is formed, the component reinforcement being attributed to diffusion and penetration of a component of the metal powder shot into the inner peripheral surface, the high hardness being attributed to miniaturization of a metal structure in the vicinity of the surface of the inner peripheral surface, and the compressive stress being accompanied by plastic deformation attributed to collision of the metal powder shot.

6. The method for reinforcing a welding tip according to claim 3, wherein, in the step of forming the surface reinforcing layer, the surface reinforcing layer to which component reinforcement, high hardness, and compressive stress are imparted is formed, the component reinforcement being attributed to diffusion and penetration of a component of the metal powder shot into the inner peripheral surface, the high hardness being attributed to miniaturization of a metal structure in the vicinity of the surface of the inner peripheral surface, and the compressive stress being accompanied by plastic deformation attributed to collision of the metal powder shot.

7. A welding tip comprising:
a surface reinforcing layer formed by ejecting a metal powder shot at least onto an inner peripheral surface of the welding tip formed of any material of copper, a copper alloy or ceramic-dispersed copper at an ejection velocity of 100 m/sec or higher, the metal powder shot having an average particle diameter of 40 μm to 150 μm and hardness equal to or higher than the material of the welding tip; and
a semiconductor film of tin oxide formed on the surface reinforcing layer by ejecting a tin powder with an average particle diameter of 10 μm to 100 μm having a tin oxide film formed thereon onto the surface reinforcing layer at an ejection velocity of 200 m/sec or higher.

8. The welding tip according to claim 7, wherein the welding tip is a contact tip which has the inner peripheral surface in sliding contact with an outer peripheral surface of an electrode and is provided at a front end of a torch for are welding.

9. The welding tip according to claim 7, wherein the welding tip is a nozzle tip which has the inner peripheral surface defining a space for introduction of plasma gas and is provided at a front end of a torch for plasma welding.

10. The welding tip according to claim 7, wherein a component of the metal powder shot is diffused and penetrated into the surface reinforcing layer and the surface reinforcing layer has a miniaturized metal structure and compressive stress.

11. The welding tip according to claim 8, wherein a component of the metal powder shot is diffused and penetrated into the surface reinforcing layer and the surface reinforcing layer has a miniaturized metal structure and compressive stress.

12. The welding tip according to claim 9, wherein a component of the metal powder shot is diffused and penetrated into the surface reinforcing layer and the surface reinforcing layer has a miniaturized metal structure and compressive stress.
